(19) United States
(12) Patent Application Publication
(10) Pub. No.: US 2023/0194231 A1
(43) Pub. Date: Jun. 22, 2023

(54) Combined Leveling and Measurement Tool for Piping Elements

(71) Applicant: Erwin Escobar, Channelview, TX (US)

(72) Inventor: Erwin Escobar, Channelview, TX (US)

(21) Appl. No.: 18/062,153

(22) Filed: Dec. 6, 2022

Related U.S. Application Data
(60) Provisional application No. 63/290,187, filed on Dec. 16, 2021.

(51) Int. Cl. G01B 3/00; G01C 9/24; G01B 3/04

(52) U.S. Cl. CPC G01B 3/002; G01C 9/24; G01B 3/04

(57) ABSTRACT

The present invention relates to a one-piece structure tool for squaring and leveling pipes and flanges, and verifying the measurements of the same. The tool is designed as both a measurement tool and a leveling tool. The tool comprises two graduated arms connected in a V-shape (i.e., acute angle), each arm has s horizontal vial(s) and vertical vial(s) for maintaining horizontal and vertical level of the flange. The graduations are used for verifying measurement of flanges and other piping elements. In various embodiments, the arms have a length of one, two, or four feet. The tool is designed to save time, effort, and money when squaring, leveling and measuring materials such as pipe flanges, pipe fittings, and pipe elements.

### CROSS-REFERENCE TO RELATED APPLICATION

The present application claims priority to, and the benefit of, U.S. Provisional Application No. 63/290,187, which was filed on Dec. 16, 2021, and is incorporated herein by reference in its entirety.

### FIELD OF THE INVENTION

The present invention relates generally to the field of pipe flanges and piping elements. More specifically, the present invention relates to a novel two-in-one tool to primarily square and level pipe flanges and other piping elements, while also verifying measurements. The tool has graduated arms for performing measurements and vials for maintaining a level in both the horizontal and vertical planes. The tool has a one-piece V-shape structure and comes in different sizes. Accordingly, the present disclosure makes specific reference thereto. Nonetheless, it is to be appreciated that aspects of the present invention are also equally applicable to other like applications, devices, and methods of manufacture.

### BACKGROUND

By way of background, pipe flanges are used for connecting pumps, pipes, valves, and other equipment to make a pipework system. Usually, flanges are threaded or welded, and two flanges can be connected by fasteners with gaskets and providing a seal that enables easy access to the piping system. Flanges and other pipe fittings when used, require leveling for which conventional levelers are used. Levelers, such as flange levelers, have different leveling vials that can include an easy-to-read high impact acrylic bubble for use as a vial. Conventional levelers are small in size and cannot be used for leveling different components positioned at relatively long distances such as two feet, four feet, and more.

While using pipe fittings and flanges, a common requirement is to measure the length of the pipes, along with measurements of inner and outer diameters of the flanges. A measurement tool, such as a scale or a measuring tape, is used by an operator for measuring length and width and even the gap between two piping elements.

An operator commonly uses separate components or tools, such as a measurement tool and a leveler for measuring size and leveling of the piping elements. As a result, the operator finds it difficult to store and operate both of the tools. Use of conventional tools in hard-to-reach areas is difficult and generally external help from another user is required in handling the tools. Therefore, individuals desire a two-in-one tool for measuring and leveling pipe flanges and other elements.

Therefore, there exists a long-felt need in the art for a device that functions as both a measurement tool and a leveling tool for pipe flanges and other applications. There is also a long-felt need in the art for a device that eliminates the requirement of two independent products for measurement and leveling of piping elements. Additionally, there is a long-felt need in the art for a piping element measuring and leveling device that can be used for large size piping elements. Moreover, there is a long-felt need in the art for a specialized piping element device that can be easily used in hard-to-reach areas. Further, there is a long-felt need in the art for a device that offers easy measurement and leveling of pipe flanges and other applications. Furthermore, there is a long-felt need in the art for a pipe flange measurement and leveling tool that can be used independently by an operator. Finally, there is a long-felt need in the art for a leveling and measurement device that saves time, effort, and money of operators in measuring and leveling materials like pipe flanges.

The subject matter disclosed and claimed herein, in one embodiment thereof, comprises a two-in-one measurement and leveling tool for pipe flanges and other piping elements. The tool has a one-piece V-shape structure and comprises two longitudinal graduated arms, the arms are connected at a common connector end, each arm has at least one horizontal level vial for horizontal leveling and at least one vertical level vial for vertical leveling. The graduations on each arm are used for verifying measurements of the piping element and flange, and for measuring gaps between two or more piping elements or flanges. The vials have alcohol with a bubble which is visible to a user for maintaining level.

In this manner, the piping element measuring and leveling combined tool of the present invention accomplishes all of the foregoing objectives and provides users with a two-in-one tool to verify pipe flange and other element measurements while keeping the items level. The tool comes in different sizes enabling the operators to work with piping elements of different sizes and positioned at different distances. The tool has multiple vials for leveling and can be used for leveling in different orientations. The tool saves time, effort, and money when measuring and leveling materials such as pipe flanges.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a combined measurement and leveling tool for pipe flanges and other piping elements. The tool is designed to eliminate the need for a separate measurement tool and a leveling tool used by operators performing pipe and maintenance work. The tool has a one-piece structure and comprises two longitudinal graduated arms, the arms are connected at a common connector end forming a V-shape of the tool, each arm has at least one horizontal level vial and at least one vertical level vial. The at least one horizontal level vial is used for leveling a piping element or flange used with the tool in a horizontal plane and the at least one vertical level vial is used for leveling the piping element or flange in a vertical or plumb plane. The graduations on each arm are used for measuring length and/or width of the piping element and flange, and for measuring gaps between two or more piping elements or flanges.

In yet another embodiment, a two-in-one tool for verifying pipe flange measurements while keeping pipe flange level is disclosed. The two-in-one tool comprised of two graduated (i.e., two foot) arms, each two-foot arm has 3R graduations along an outer edge of its length, each two-foot arm has a horizontal vial tube and a vertical vial tube, the vial tubes are banana shaped or barrel shaped and have alcohol with a bubble for leveling, the graduations are used for measurement of an inner diameter and an outer diameter of the pipe flange while the vials are used for maintaining horizontal and vertical alignment of the flange.

In yet another embodiment, each arm has a length of one foot.

In yet another embodiment, each arm has a length of four feet.

In yet another embodiment, a two-in-one tool for verifying pipe flange measurements while keeping pipe flange level is disclosed. The two-in-one tool comprising of two graduated four-foot arms, each four-foot arm has graduations along an outer edge of their length, each four-foot arm has a pair of horizontal vial tubes and a pair of vertical vial tubes, the vial tubes are banana shaped or barrel shaped and have alcohol with a bubble for leveling, the graduations are used for measurement of an inner diameter and an outer diameter of the pipe flange while the vials are used for maintaining horizontal and vertical alignment of the flange.

An objective of the two-in-one tool of the present invention is to allow users to save time and effort when performing pipe and maintenance work. The tool can be used for different piping elements such as flanges, pipes, and more.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a combined leveling and measurement tool of the present invention in accordance with the disclosed architecture;

FIG. 2 illustrates a perspective view showing use of the leveling and measurement tool of FIG. 1 for measuring the inner diameter of a pipe flange while the flange is leveled in accordance with the disclosed architecture;

FIG. 3 illustrates a perspective view showing use of the combined leveling and measurement tool of the present invention in aligning pipe fittings in accordance with the disclosed architecture;

FIG. 4 illustrates a perspective view showing use of the two-in-one tool of one embodiment of the present invention used for aligning a pair of pipe flanges in accordance with the disclosed architecture;

FIG. 5 illustrates another embodiment of the combined leveling and measurement tool of the present invention in accordance with the disclosed architecture; and

FIG. 6 illustrates yet another embodiment of the combined leveling and measurement tool of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that functions as both a measurement tool and a leveling tool for pipe flanges and other applications. There is also a long-felt need in the art for a device that eliminates the requirement of two independent products for measurement and leveling of piping elements. Additionally, there is a long-felt need in the art for a piping element measuring and leveling device that can be used for large size piping elements. Moreover, there is a long-felt need in the art for a specialized piping element device that can be used easily in hard-to-reach areas. Further, there is a long-felt need in the art for a device that offers easy measurement and leveling of pipe flanges and other applications. Furthermore, there is a long-felt need in the art for a pipe flange measurement and leveling tool that can be used independently by an operator. Finally, there is a long-felt need in the art for a leveling and measurement device that saves time, effort, and money of operators in measuring and leveling materials like pipe flanges.

The present invention, in one exemplary embodiment, is a two-in-one tool for verifying pipe flange measurements while maintaining pipe flange level. The two-in-one tool comprises two graduated two-foot arms, each two-foot arm has 3R graduations along an outer edge of its length, each two-foot arm has a horizontal vial tube and a vertical vial tube, the vial tubes are banana shaped or barrel shaped and have alcohol with a bubble for leveling, the graduations are used for measurement of an inner diameter and an outer diameter of pipe flange while the vials are used for maintaining horizontal and vertical alignment of the flange.

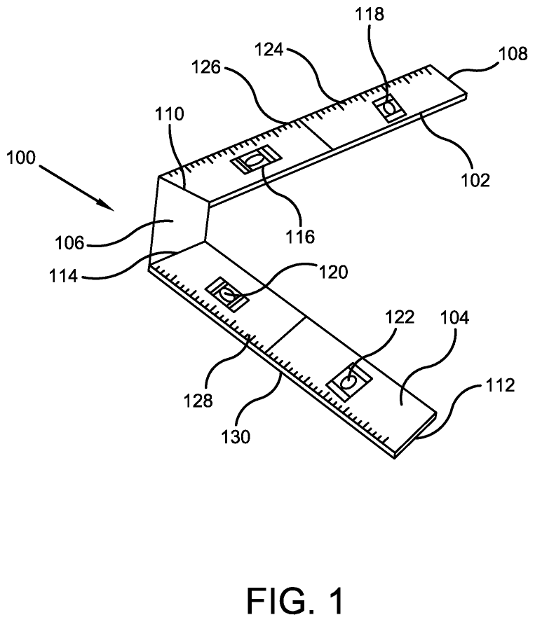

Referring initially to the drawings, FIG. 1 illustrates a perspective view of one potential embodiment of the combined leveling and measurement tool of the present invention in accordance with the disclosed architecture. The combined leveling and measurement tool 100 of the present embodiment is designed as a specialized two-in-one tool for verifying pipe flange and other piping element measurements while keeping the elements level. More specifically, the tool 100 is substantially V-shaped and has two identical arms 102, 104 integrally connected at the connector end or portion 106. In one exemplary embodiment, each arm 102, 104 has a length of one foot. The first arm 102 extends from the free end 108 to the connected end 110 and the second arm 104 extends from the free end 112 thereof to the connected end 114 thereof. Each arm has a width of about 1.5″ enabling easy storage and use of the tool 100.

More specifically, the tool 100 can be constructed using plastic, aluminum, wood, and other suitable materials, and each arm 102, 104 can have a pair of leveling vials for enabling a user to level different piping elements using the tool 100. As illustrated, the arm 102 has the vials 116, 118; the horizontal vial 116 is configured to measure/indicate a horizontal plane and the vertical vial 118 is configured to measure/indicate a vertical plane when the arm 102 is used with a pipe flange or any other piping element. Similarly, the arm 104 has a horizontal vial 120 and a vertical vial 122 for leveling piping elements.

The plurality of leveling vials are designed as bubble level vials that are made of banana-shaped curved glass having a colored spirit or alcohol, leaving a bubble in the vial. The vials, in different embodiments of the present invention, use alcohol such as ethanol encapsulated therein as ethanol has very low viscosity and surface tension which allows the bubble to travel the tube quickly and settle accurately with minimal interference with the glass surface.

The arms 102, 104 have continuous graduations that allow the arms 102, 104 to function as a measuring device for measuring length and/or width of piping items. The first arm 102 has evenly distributed graduations 124 along the outer edge 126 thereof and similarly, the second arm 104 has evenly distributed graduations 128 along the outer edge 130 thereof. The graduations can be designed as 3R, 4R, 5R, and more, as per requirements of users of the tool 100. It is to be appreciated that 3R represents 1/64″, 1/50″, 1/32″, 1/10″ graduations; 4R represents 1/64″, 1/32″, 1/16″, ⅛″ graduations; and 5R represents 1/100″, 1/64″, 1/32″, 1/10″ graduations.

The connector end or connector portion 106 is generally rectilinear and makes an angle from about 130° to about 150° . The arms 102, 104 substantially form the V-shape with the free ends 108, 112 positioned away from each other. The arms 102, 104 extend at an acute angle 105 relative to each other. In one exemplary arrangement, the acute angle 105 is from about 50° to about 70°. The tool 100 can be used, for example, in construction sites, shop maintenance, decorative applications, electrical installations, water piping, etc.

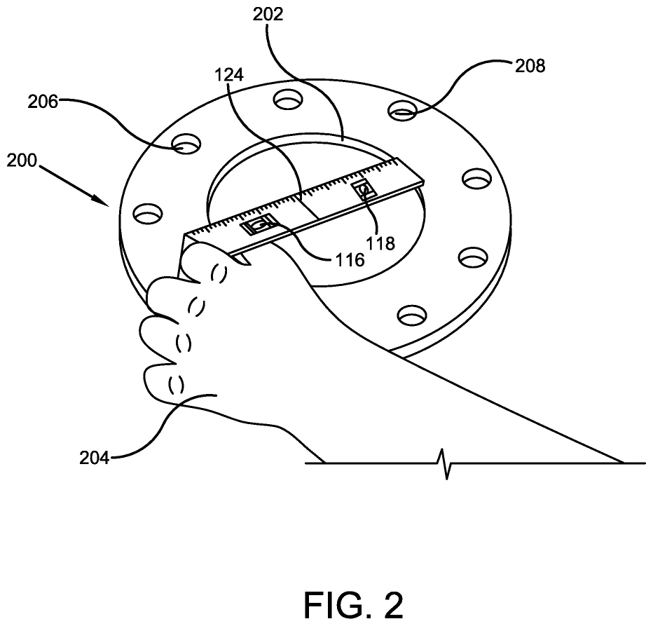

FIG. 2 illustrates use of the leveling and measurement tool of FIG. 1 for measuring the inner diameter of a pipe flange while the flange is leveled in accordance with the disclosed architecture. The graduations on the arms 102, 104 allow a user to use one hand 204 for measuring a length and a width of items. As illustrated, the arm 102 is positioned between two points of the inner periphery 202 of the flange 200 and the graduations 124 are used for measuring the inner diameter of the flange 200. While, the inner diameter is measured by an operator, the horizontal vial 116 and the vertical vial 118 are used for leveling the flange 200 in both horizontal plane and vertical plane, thereby eliminating use of separate tools and separate operations of leveling and measurement.

It should be noted that the tool 100 can be used between any two holes such as exemplary holes 206, 208 of the flange 200 for measuring the distance and also for fastening the tool 100 to the flange 200 during an operation such as turning or rotating the flange.

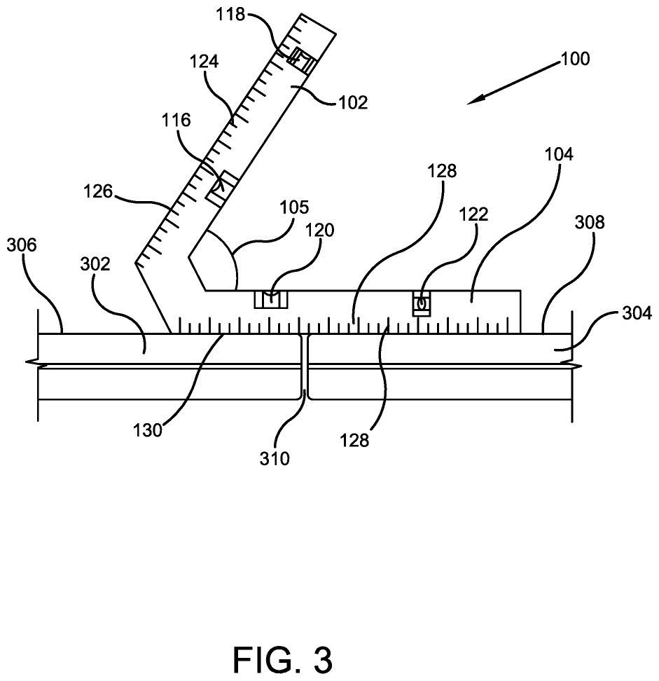

FIG. 3 illustrates a perspective view showing use of the combined leveling and measurement tool of the present invention in aligning pipe fittings in accordance with the disclosed architecture. In the present embodiment, the two pipe fittings 302, 304 are aligned and positioned using the tool 100 without requiring multiple tools. As illustrated, one arm 104 of the tool 100 is positioned in a desired position on the top edges 306, 308 of the pipe fittings 302, 304, respectively. A gap 310 is maintained between the fittings 302, 304 using the graduations 128 of the arm 104.

The level vials 120, 122 provide horizontal and vertical alignment and orientation of the pipe fittings 302, 304 and accordingly, the pipe fittings 302, 304 can be aligned in any direction and orientation.

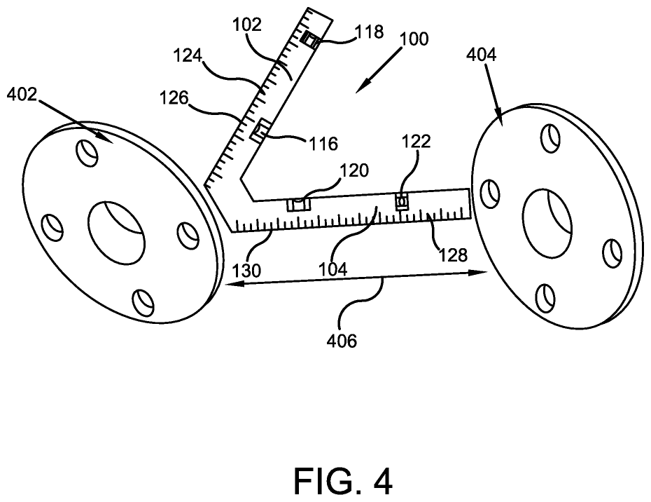

FIG. 4 illustrates a perspective view showing use of the two-in-one tool of one embodiment of the present invention used for aligning a pair of pipe flanges in accordance with the disclosed architecture. The tool of various embodiments of the present invention can be used for aligning and leveling multiple flanges of different sizes. As illustrated, the flanges 402, 404; each having plurality of holes used for securing different pipe fittings are aligned using at least one arm 102 (or 104) of the tool 100. The desired gap 406 between the flanges 402, 404 is maintained using the length of the arm 102 while the vials 116, 118 are used for determining the horizontal and vertical planes of the flanges 402, 404.

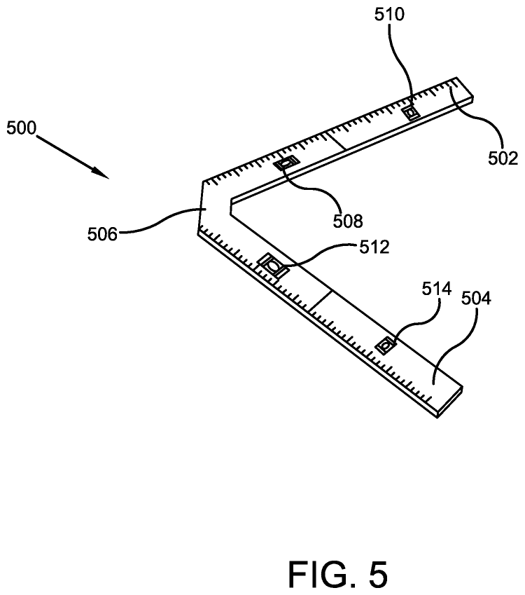

FIG. 5 illustrates another embodiment of the combined leveling and measurement tool of the present invention in accordance with the disclosed architecture. In the present embodiment, the tool 500 has two identical arms 502, 504, each having a two-foot length and connected to a common connector end 506. Similar to the tool 100 of FIG. 1, the arm 502 has two vials, a horizontal vial 508 and a vertical vial 510.

The second arm 504 also has two symmetrical vials, a horizontal vial 512 and a vertical vial 514. The width of the arms 502, 504 is about 2″ and the tool 500 can be made from plastic, aluminum, wood, and other suitable material. The tool 500 is used for creating long spacing between piping components and also used with large size piping elements.

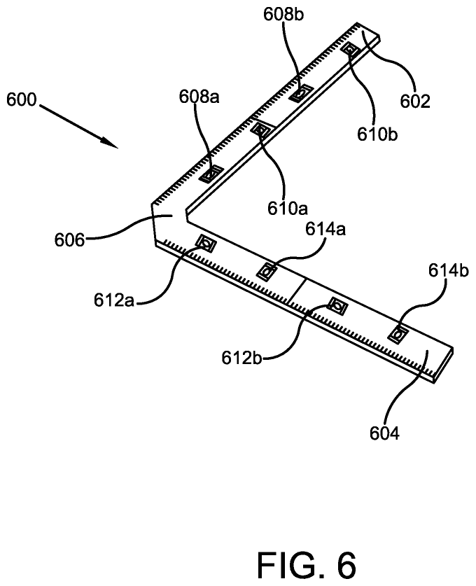

FIG. 6 illustrates yet another embodiment of the combined leveling and measurement tool of the present invention in accordance with the disclosed architecture. In the present embodiment, the tool 600 has two identical arms 602, 604, each having generally a four-foot length and connected to a common connector end 606. The arm 602 has two horizontal vials 608a, 608b and two vertical vials 610a, 610b. The second arm 604 also has two horizontal vials 612a, 612b and two vertical vials 614a, 614b. The increased number of vials on both arms 602, 604 is due to the fact that the length of the arms 602, 604 is around four feet and a pair of horizontal vials and a pair of vertical vials provide accurate leveling. The width of the arms 602, 604 is about 2″ and the tool 600 can be made from plastic, aluminum, wood, and other suitable material.

The vials, used in different embodiments of the present invention, are accurate to five-ten-thousandth of an inch (0.0005) per inch and have green/yellow color for easy visibility. The vials can be banana-shaped tubes or can be barrel-shaped tubes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “two-in-one tool”, “combined leveling and measurement tool”, “leveling and measurement tool”, “device”, and “tool” are interchangeable and refer to the combined pipe fittings leveling and measurement tool 100,500,600 of the present invention.

Notwithstanding the foregoing, the combined pipe fittings leveling and measurement tool 100, 500, 600 of the present invention can be of any suitable size and configuration as is known in the art without affecting the overall concept of the invention, provided that it accomplishes the above-stated objectives. One of ordinary skill in the art will appreciate that the combined pipe fittings leveling and measurement tool 100, 500, 600 as shown in the FIGS. are for illustrative purposes only, and that many other sizes and shapes of the combined pipe fittings leveling and measurement tool 100, 500, 600 are well within the scope of the present disclosure. Although the dimensions of the combined pipe fittings leveling and measurement tool 100, 500, 600 are important design parameters for user convenience, the combined pipe fittings leveling and measurement tool 100, 500, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A combined leveling and measurement tool for verifying piping measurements comprising:
a tool having a generally V-shape including a first arm and a second arm;
a connector portion connecting said first arm and said second arm;
wherein said first arm having a plurality of leveling vials for determining level of piping elements and a plurality of graduations for measuring sizes of said piping elements;
wherein said second arm having a plurality of leveling vials for determining level of said piping elements and a plurality of graduations for measuring sizes of said piping elements;
wherein said plurality of leveling vials of said first arm having a horizontal vial to indicate a horizontal plane of said piping elements and a vertical vial to indicate a vertical plane of said piping elements;
wherein said plurality of leveling vials of said second arm having a horizontal vial to indicate a horizontal plane of said piping elements and a vertical vial to indicate a vertical plane of said piping elements;
wherein said plurality of graduations of said first arm having evenly distributed graduations along an outer edge of said first arm;
wherein said plurality of graduations of said second arm having evenly distributed graduations along an outer edge of said second arm; and
further wherein said plurality of graduations are selected from a group consisting of a 3R, a 4R, and a 5R graduation scale.

2. The combined leveling and measurement tool of claim 1, wherein each said first arm and said second arm having a length of generally one foot.

3. The combined leveling and measurement tool of claim 1, wherein each said first arm and said second arm having a length of generally two feet.

4. The combined leveling and measurement tool of claim 1, wherein each said first arm and said second arm having a length of generally four feet.

5. The combined leveling and measurement tool of claim 2, wherein each said first arm and said second arm having a width of at least 1.5″.

6. The combined leveling and measurement tool of claim 1, wherein said tool constructed of a material selected from a group consisting of a plastic, an aluminum, and a wood.

7. The combined leveling and measurement tool of claim 5, wherein said plurality of leveling vials are bubble level vials having colored ethanol encapsulated therein.

8. The combined leveling and measurement tool of claim 1, wherein said connector portion is rectilinear.

9. The combined leveling and measurement tool of claim 8, wherein said first arm extends at an acute angle relative to said second arm.

10. The combined leveling and measurement tool of claim 9, wherein said acute angle is from about 50 degrees to about 70 degrees.

11. A combined leveling and measurement tool for verifying piping measurements comprising:
a tool having a generally V-shape including a first arm and a second arm;
a connector portion connecting said first arm and said second arm;
wherein said first arm having a plurality of leveling vials for determining level of piping elements and a plurality of graduations for measuring sizes of said piping elements;
wherein said second arm having a plurality of leveling vials for determining level of said piping elements and a plurality of graduations for measuring sizes of said piping elements;
wherein said plurality of leveling vials of said first arm having a horizontal vial to indicate a horizontal plane of said piping elements and a vertical vial to indicate a vertical plane of said piping elements;
wherein said plurality of leveling vials of said second arm having a horizontal vial to indicate a horizontal plane of said piping elements and a vertical vial to indicate a vertical plane of said piping elements;
wherein said plurality of graduations of said first arm having evenly distributed graduations along an outer edge of said first arm;
wherein said plurality of graduations of said second arm having evenly distributed graduations along an outer edge of said second arm;
wherein said first arm extends at an acute angle relative to said second arm; and
further wherein said acute angle is from about 50 degrees to about 70 degrees.

12. The combined leveling and measurement tool of claim 11, wherein each said first arm and said second arm having a length of at least one foot.

13. The combined leveling and measurement tool of claim 11, wherein each said first arm and said second arm having a length of at least two feet.

14. The combined leveling and measurement tool of claim 12, wherein each said first arm and said second arm having a width of at least 1.5″.

15. The combined leveling and measurement tool of claim 11, wherein said tool constructed of a material selected from a group consisting of a plastic, an aluminum, and a wood.

16. The combined leveling and measurement tool of claim 11, wherein said plurality of leveling vials are bubble level vials having colored ethanol encapsulated therein.

17. The combined leveling and measurement tool of claim 11, wherein said plurality of graduations are selected from a group consisting of a 3R, a 4R, and a 5R graduation scale.

18. A combined leveling and measurement tool for verifying piping measurements comprising:
a tool having a generally V-shape including a first arm and a second arm;
a connector portion connecting said first arm and said second arm;
wherein said first arm having a plurality of leveling vials for determining level of piping elements and a plurality of graduations for measuring sizes of said piping elements;
wherein said second arm having a plurality of leveling vials for determining level of said piping elements and a plurality of graduations for measuring sizes of said piping elements;
wherein said plurality of leveling vials of said first arm having a pair of horizontal vials to indicate a horizontal plane of said piping elements and a pair of vertical vials to indicate a vertical plane of said piping elements;
wherein said plurality of leveling vials of said second arm having a pair of horizontal vials to indicate a horizontal plane of said piping elements and a pair of vertical vials to indicate a vertical plane of said piping elements;
wherein said plurality of graduations of said first arm having evenly distributed graduations along an outer edge of said first arm;
wherein said plurality of graduations of said second arm having evenly distributed graduations along an outer edge of said second arm; and
further wherein said first arm extends at an acute angle relative to said second arm.

19. The combined leveling and measurement tool of claim 18, wherein said acute angle is from about 50 degrees to about 70 degrees.

20. The combined leveling and measurement tool of claim 19, wherein each said first arm and said second arm having a length of at least three feet.
